(19) United States
(12) Patent Application Publication
(10) Pub. No.: US 2010/0330328 A1
(43) Pub. Date: Dec. 30, 2010

(54) FINGER NAPKIN

(76) Inventor: KYONG SEOK LEE, Los Angeles, CA (US)

Correspondence Address: PARK LAW FIRM, 3255 WILSHIRE BLVD, SUITE 1110, LOS ANGELES, CA, 90010, US

(21) Appl. No.: 12/495,294

(22) Filed: Jun. 30, 2009

(51) Int. Cl. B32B 3/06

(52) U.S. Cl. 428/99

(57) ABSTRACT

A finger napkin, adapted to receive a finger for use while eating food, comprises a body configured to comprise a curved surface for conforming to the finger and a fastening means for securing the finger napkin to the finger. The body of the finger napkin comprises an inner layer and an outer layer wherein the inner layer is made of flexible material for enclosing the finger and the outer layer is made of paper or cloth napkin for contacting food. The finger napkin prevents fingers from soiling or burn while eating. In addition, the finger napkin makes it easier to hold and manipulate food while eating; and helps for the cleanness of eating.

### BACKGROUND OF THE INVENTION

The present invention relates to a napkin configured to enclose a finger. More particularly, this invention relates to a finger napkin adapted to receive a finger for use while eating food, which comprises a body configured to comprise a curved surface for conforming to the finger and a fastening means for securing the finger napkin to the finger.

People tend to use fingers to eat French fries, hamburger, chicken, etc., but it is inevitable to get their fingers soiled by messy food, or even worse, they may get burned by hot food. A napkin is generally a rectangle of paper or cloth used at the table for wiping the mouth or hands while eating and some people use napkins to hold food in the hope to prevent the soiling or burn of fingers. However, they soon find out juice from food smears or exudes through the napkins, soiling their fingers. Even if they are successful in keeping their fingers from soiling by using napkins, it is easy for the napkins to become messy with juice or pieces of messy food and it is hard to hold and manipulate food as they want using napkins.

Accordingly, a need for a finger napkin adapted to receive a finger for use while eating food has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a finger napkin adapted to receive a finger for use while eating food.

Another object of the invention is to provide a finger napkin adapted to receive a finger for use while eating food, which comprises a body configured to comprise a curved surface for conforming to the finger and a fastening means for securing the finger napkin to the finger.

Still another object of the invention is to provide a finger napkin adapted to receive a finger for use while eating food, which comprises a body configured to comprise a curved surface for conforming to the finger comprising an inner layer and an outer layer wherein the inner layer is made of flexible material for enclosing the finger and the outer layer is made of paper or cloth napkin for contacting food, and a fastening means for securing the finger napkin to the finger.

An aspect of the invention provides a means to prevent food from slippage.

The advantages of the present invention are: (1) the finger napkin prevents fingers from soiling while eating; (2) the finger napkin prevents fingers from burn by hot food; (3) the finger napkin makes it easier to hold and manipulate food while eating; and (4) the finger napkin helps for the cleanness of eating.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front view showing a hand wearing two finger napkins 100 according to an embodiment of the present invention;

FIG. 2A is a perspective view showing a finger napkin 100 according to an embodiment of the present invention; and

FIG. 2B is an X-Y sectional view of FIG. 2A showing an inner layer 16 and an outer layer 18 of a body 10 of a finger napkin 100.

FIG. 3 is a perspective view showing an alternative embodiment of a finger napkin 100 wherein an attachment means 20 and an inner layer 16 are integrated into one.

FIG. 4 is a perspective view showing an alternative embodiment of a finger napkin 100 wherein a round end 12 is elongated to accommodate a long fingernail.

FIG. 5 is a perspective view showing an alternative embodiment of a finger napkin 100 wherein an outer layer 18 is configured to have a plurality of resilient protrusions 22 for preventing slippage of food.

### DETAILED DESCRIPTION EMBODIMENTS OF THE INVENTION

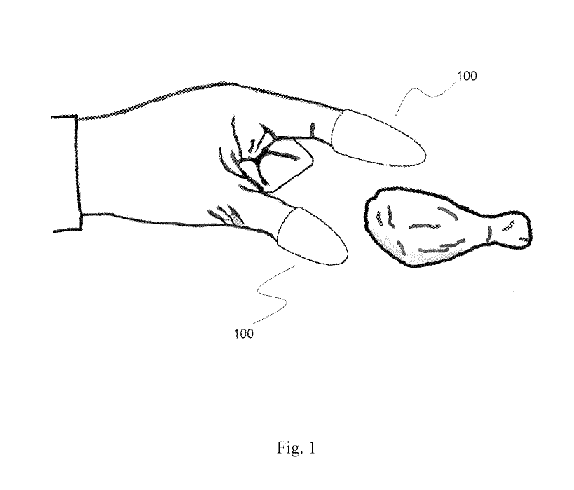

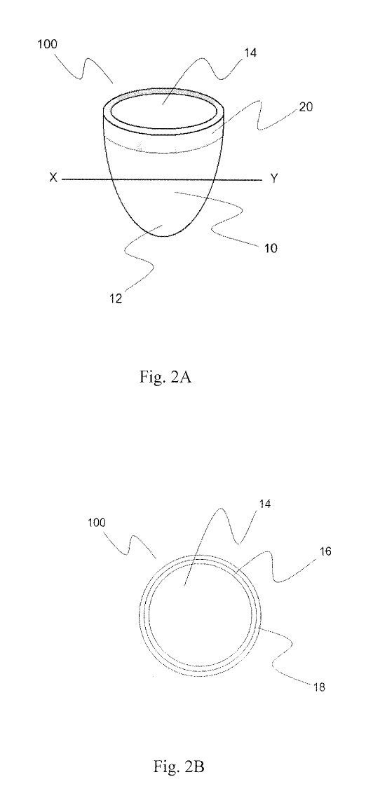

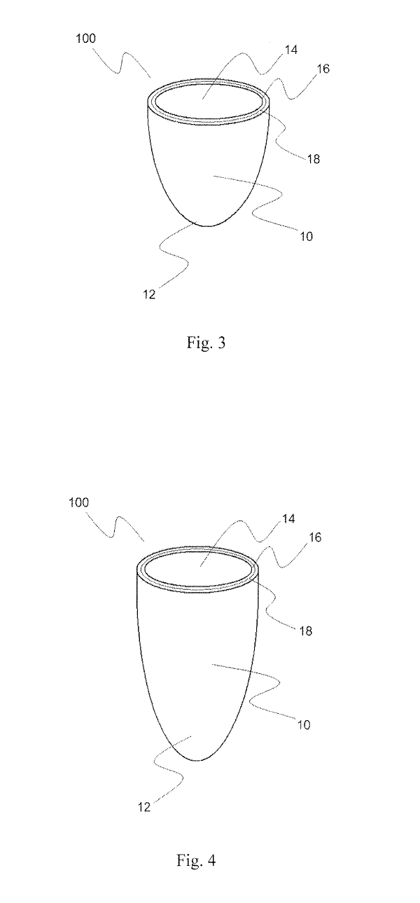

FIGS. 1, 2A and 2B show a finger napkin 100 according to an embodiment of the present invention. FIGS. 3-5 show a finger napkin 100 according to another embodiment of the invention.

FIG. 1 shows a hand wearing two finger napkins 100 according to an embodiment of the present invention. Some people may use as many finger napkins as they want for thumb, index finger, middle finger, ring finger, or little finger, depending on their convenience in eating.

FIG. 2A shows a finger napkin 100 adapted to receive a finger for use while eating food, which comprise: a body 10 configured to comprise a curved surface for conforming to the finger with a round end 12 for enclosing a tip of the finger and an opening end 14 for receiving the finger, comprising an inner layer 16 and an outer layer 18 wherein the inner layer is made of flexible material for enclosing the finger, the outer layer is made of napkin for contacting food, and the inner layer 16 and the outer layer 18 are attached by adhesive material to prevent slippage; and a fastening means 20 attached to or integrated into the body 10 for securing the finger napkin to the finger.

The outer layer 18 of the body 10 may comprise a plurality of napkins piled together. A pile of napkins will prevent juice of food from smearing or exuding toward the finger.

FIG. 2B shows an X-Y sectional view of FIG. 2A showing an inner layer 16 and an outer layer 18 of a body 10 of a finger napkin 100. The outer layer 18 and inner layer 16 of the body 10 may be integrated into one. Additionally, the integrated inner layer and outer layer may have an attachment function itself.

The flexible material of the inner layer 16 may comprise napkin.

The inner layer 16 may be coated with impermeable water-proof material. The finger may feel better with the impermeable water-proof material.

The inner layer 16 of the body 10 may comprise impermeable water-proof material.

The impermeable water-proof material of the inner layer 16 may be non-adhesive as well.

The inner layer 16 of the body 10 may comprise absorbent material. Some people may feel better with the absorbent material of the inner layer 16 because of their sweaty hand or other reasons.

The absorbent material of the inner layer 16 may be non-adhesive as well.

The absorbent material of the inner layer 16 may comprise fabric.

The inner layer and the fastening means may be integrated into one knitted or woven type of hosiery for enclosing the finger and fastening the finer napkin to the finger.

The fastening means is at the rim of the open end. FIG. 2A shows this kind of embodiment.

FIG. 3 shows another embodiment of this invention wherein the fastening means comprises rubber band integrated into the body. The inner layer 16 of the body 10 may comprise the rubber band or other attachment means for securing the finger napkin 100 to the finger.

The inner layer 16 and outer layer 18 of the body 10 may respectively comprise two layers of sheet material connected by mechanical stitching along the peripheral portion of the layers except the open end. In this embodiment, the shape of the finger napkin 100 may be similar to that of a thimble.

FIG. 4 shows an alternative embodiment of a finger napkin 100 comprising elongated round end 12. The round end 12 of the body 10 may be elongated for fitting the finger napkin on the finger with a long fingernail. Some people may have long fingernails and the elongated round end 12 will accommodate the long fingernail. Alternatively, the size of the finger napkin 100 may vary depending on whether the user is a child, man or woman.

The finger napkin 100 adapted to receive a finger for use while eating food may comprise a body 10 configured to comprise a curved surface for conforming to the finger with a round end 12 for enclosing a tip of the finger and an opening end 14 for receiving the finger, comprising an inner layer 16 and an outer layer 18 wherein the inner layer 16 is made of flexible material for enclosing the finger, the outer layer 18 comprises absorbent material for contacting food, and the inner layer 16 and the outer layer 18 are attached by adhesive material to prevent slippage, and a fastening means 20 attached to or integrated into the body 10 for securing the finger napkin 100 to the finger. Here, the absorbent material of the outer layer 18 may be fabric.

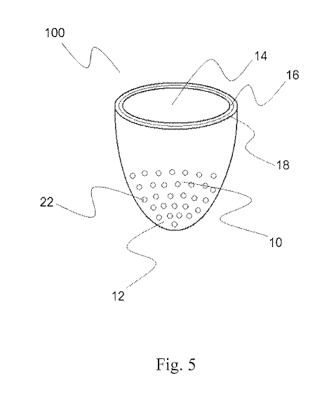

Alternatively, the finger napkin 100 adapted to receive a finger for use while eating food may comprise a body 10 configured to comprise a curved surface for conforming to the finger with a round end 12 for enclosing a tip of the finger and an opening end 14 for receiving the finger, comprising an inner layer 16 and an outer layer 18 wherein the inner layer 16 is made of flexible material for enclosing the finger, the outer layer 18 comprises non-absorbent material for contacting food, and the inner layer 16 and the outer layer 18 are attached by adhesive material to prevent slippage, and a fastening means attached to or integrated into the body for securing the finger napkin 100 to the finger. Here, the non-absorbent material of the outer layer 18 may be vinyl. In addition, the vinyl of the outer layer 18 may be configured to have a plurality of resilient protrusions 22 as shown in FIG. 5.

The outer layer 18 may comprise eight folds of paper napkins with 12˜16 g/m² (2 plies) in thickness and the thickness of inner layer 16 is the same as that of single fold of paper napkin. As the number of paper napkin layer increase, prevention of food smearing increases but the feel of food by a finder decreases. Thus, according to tests, the best compromise between these two objectives is eight folds of ordinary paper napkins.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A finger napkin adapted to receive a finger for use while eating food, comprising:
a body configured to comprise a curved surface for conforming to the finger with a round end for enclosing a tip of the finger and an opening end for receiving the finger, comprising an inner layer and an outer layer wherein the inner layer is made of flexible material for enclosing the finger, the outer layer is made of napkin for contacting food, and the inner layer and the outer layer are attached by adhesive material to prevent slippage; and
a fastening means attached to or integrated into the body for securing the finger napkin to the finger.

2. The finger napkin of claim 1, wherein the outer layer of the body comprises a plurality of napkins piled together.

3. The finger napkin of claim 1, wherein the outer layer and inner layer of the body are integrated into one.

4. The finger napkin of claim 1, wherein the flexible material of the inner layer comprises napkin.

5. The finger napkin of claim 4, wherein the inner layer is coated with impermeable water-proof material.

6. The finger napkin of claim 1, wherein the round end of the body is elongated for fitting the finger napkin on the finger with a long fingernail.

7. The finger napkin of claim 1, wherein the inner layer of the body comprises impermeable water-proof material.

8. The finger napkin of claim 7, wherein the impermeable water-proof material is non-adhesive.

9. The finger napkin of claim 1, wherein the inner layer of the body comprises absorbent material.

10. The finger napkin of claim 9, wherein the absorbent material of the inner layer is non-adhesive.

11. The finger napkin of claim 10, wherein the absorbent material comprises fabric.

12. The finger napkin of claim 1, wherein the inner layer and the fastening means are integrated into one knitted or woven type of hosiery for enclosing the finger and fastening the finer napkin to the finger.

13. The finger napkin of claim 1, wherein the fastening means is at the rim of the open end.

14. The finger napkin of claim 1, wherein the fastening means comprises rubber band integrated into the body.

15. The finger napkin of claim 1, wherein the inner layer and outer layer of the body respectively comprise two layers of sheet material connected by mechanical stitching along the peripheral portion of the layers except the open end.

16. A finger napkin adapted to receive a finger for use while eating food, comprising:
a body configured to comprise a curved surface for conforming to the finger with a round end for enclosing a tip of the finger and an opening end for receiving the finger, comprising an inner layer and an outer layer wherein the inner layer is made of flexible material for enclosing the finger, the outer layer comprises absorbent material for contacting food, and the inner layer and the outer layer are attached by adhesive material to prevent slippage; and
a fastening means attached to or integrated into the body for securing the finger napkin to the finger.

17. The finger napkin of claim 16, wherein the absorbent material of the outer layer is fabric.

18. A finger napkin adapted to receive a finger for use while eating food, comprising:
a body configured to comprise a curved surface for conforming to the finger with a round end for enclosing a tip of the finger and an opening end for receiving the finger, comprising an inner layer and an outer layer wherein the inner layer is made of flexible material for enclosing the finger, the outer layer comprises non-absorbent material for contacting food, and the inner layer and the outer layer are attached by adhesive material to prevent slippage; and
a fastening means attached to or integrated into the body for securing the finger napkin to the finger.

19. The finger napkin of claim 18, wherein the non-absorbent material of the outer layer is vinyl.

20. The finger napkin of claim 18, wherein the vinyl of the outer layer is configured to have a plurality of resilient protrusions.
